(19) United States
(12) Patent Application Publication
(10) Pub. No.: US 2008/0198584 A1
(43) Pub. Date: Aug. 21, 2008

(54) Building Structures Having Electrically Functional Architectural Surfaces

(75) Inventors: Alain-Geoffrey Fouraux, Zuid-Holland (NL); David Zuman, Rehovot (IL)

Correspondence Address: DARBY & DARBY P.C., P.O. BOX 770, Church Street Station, New York, NY, 10008-0770, US

(73) Assignee: NERVECORP LIMITED, Mahe (SC)

(21) Appl. No.: 11/914,538

(22) PCT Filed: May 16, 2006
(86) PCT No.: PCT/IL06/00577

§ 371 Date: Feb. 7, 2008

Related U.S. Application Data
(60) Provisional application No. 60/682,219, filed on May 17, 2005.

(51) Int. Cl. E04C 2/52; E04B 2/88; E06B 3/67; E06B 3/66; F21S 8/00; H04R 1/02

(52) U.S. Cl. 362/147; 52/173.1; 52/745.2; 52/786.1; 52/788.1; 381/87

(57) ABSTRACT

A building structure (100) including at least one architectural surface (108) including at least one substrate having electrical circuitry including patterned electrical conductors (110) and at least one electrical component (112) formed on the at least one substrate (108), least one substrate 108 being of at least one of transparent and flexible.

### REFERENCE TO RELATED APPLICATIONS

Reference is made to U.S. Provisional Patent Application No. 60/682,219, entitled VIDEOSKIN, filed May 17, 2005, the disclosure of which is hereby incorporated by reference and priority of which is hereby claimed pursuant to 37 CFR 1.78(a) (4) and (5)(i).

### FIELD OF THE INVENTION

The present invention relates to building structures generally and more particularly to building structures having electrically functional architectural surfaces.

### BACKGROUND OF THE INVENTION

The following Patents and Patent publications are believed to represent the current state of the art:

U.S. Pat. Nos. 6,673,427; 6,602,587; 6,551,715; 4,970,812; 6,677,918; 6,237,290; 6,883,286; 6,911,593 and 7,034,470;

U.S. Patent Application Publication Nos.: 2001/0039771 and 2006/0039142;

PCT Patent Application Publication Nos.: WO2005/098978 and WO2004/100113;

European Patent Application Publication Nos.: EP1460609; EP1594109 and EP0900971; and

Japanese Patent No. 8-36367.

### SUMMARY OF THE INVENTION

The present invention seeks to provide improved building structures.

There is thus provided in accordance with a preferred embodiment of the present invention, a building structure including at least one architectural surface including at least one substrate having electrical circuitry including patterned electrical conductors and at least one electrical component, formed onto the at least one substrate, the at least one substrate being at least one of transparent and flexible.

In accordance with a preferred embodiment of the present invention the at least one electrical component is operative to be at least one of powered thereby and providing power thereto.

In accordance with another preferred embodiment of the present invention the at least one architectural surface includes a flexible wall surface of the building structure. Preferably, the at least one architectural surface includes a wall surface of a temporary building.

In accordance with yet another preferred embodiment of the present invention the at least one architectural surface includes an outer wall surface of the building structure. Preferably, the outer wall surface includes at least one of a side wall surface, a corner wall surface and a roof surface. Alternatively, the at least one architectural surface includes an inner wall surface of the building structure. Preferably, the inner wall surface includes at least one of a floor surface, a ceiling surface, a side wall surface and a corner surface.

In accordance with still another preferred embodiment of the present invention the at least one architectural surface includes a curved architectural surface. Preferably, at least one side of the at least one architectural surface includes a visible display. Preferably, the visible display includes a video display.

In accordance with a further preferred embodiment of the present invention a first side of the at least one architectural surface includes a first visible display and a second side of the at least one architectural surface includes a second visible display. Preferably, the first visible display and the second visible display are identical. Alternatively, the first visible display and the second visible display are different.

In accordance with yet a further preferred embodiment of the present invention the at least one architectural surface is highly transparent to visible light. Alternatively, the at least one substrate is generally translucent to visible light. As a further alternative, the at least one substrate is generally opaque to visible light.

In accordance with still a further preferred embodiment of the present invention the at least one substrate includes glass. Alternatively, the at least one substrate includes at least one flexible substrate. Preferably, the at least one flexible substrate includes at least one of polyester film and polyamide film.

In accordance with an additional further preferred embodiment of the present invention the patterned electrical conductors are formed by conductive ink. Preferably, the conductive ink is generally transparent to visible light.

In accordance with another preferred embodiment of the present invention the patterned electrical conductors are printed onto the at least one substrate. Preferably, the patterned electrical conductors are digitally printed onto the at least one substrate. Additionally or alternatively, the patterned electrical conductors include a first plurality of patterned electrical conductors printed onto a first side of the at least one substrate and a second plurality of patterned electrical conductors printed onto a second side of the at least one substrate.

In accordance with yet another preferred embodiment of the present invention the at least one electrical component includes at least one energy collection and storage element operative to provide electrical power. Alternatively, the at least one electrical component includes at least one electrically powered component. Preferably, the patterned electrical conductors include electrical power conductors which supply electrical power to the at least one electrically powered component. Additionally or alternatively, the electrical power conductors provide control information to the at least one electrically powered component.

In accordance with still another preferred embodiment of the present invention the at least one electrically powered component includes at least one of a light emitting element, a sound emitting element, a temperature governing element, a climate control element, an environmental sensor, a motion sensor and a pressure sensor. Preferably, the at least one light emitting element includes at least two light emitting elements, facing in opposite directions with respect to the at least one substrate.

In accordance with a further preferred embodiment of the present invention the light emitting element includes at least one of an LED, an OLED light module and an EL light module. Additionally or alternatively, the sound emitting element includes at least one of an audio transducer, a speaker and a microphone.

In accordance with yet a further preferred embodiment of the present invention the at least one electrical component is mounted onto the at least one substrate by an adhesive. Preferably, the adhesive includes an electrically conductive adhesive. Additionally or alternatively, the at least one electrical component is mounted onto the at least one substrate by SMT mounting.

In accordance with still a further preferred embodiment of the present invention the patterned electrical conductors include multiple layers of patterned electrical conductors electrically insulated from each other by a generally visible-light transmissive dielectric material.

In accordance with another further preferred embodiment of the present invention the at least one architectural surface includes at least one environmental protective element associated with the at least one substrate. Additionally or preferably, the at least one architectural surface includes at least one space defining element associated with the at least one substrate.

In accordance with an additional preferred embodiment of the present invention at least one of the at least one environmental protective element and the at least one space defining element is transparent to visible light. Preferably, at least one of the at least one environmental protective element and the at least one space defining includes a pair of glass environmental protective elements enclosing the at least one substrate therebetween.

Alternatively, at least one of the at least one environmental protective element and the at least one space defining element includes a single flexible environmental protective element or a single flexible space defining element. Preferably, the flexible environmental protective element and/or the flexible space defining element is formed of at least one of polyester film and polyamide film. Additionally and preferably, the patterned electrical conductors are enclosed between the at least one substrate and the flexible environmental protective element or between the at least one substrate and the flexible space defining element.

In accordance with another preferred embodiment of the present invention the at least one environmental protective element and/or the at least one space defining element includes an opaque panel having at least one aperture formed therein. Preferably, at least one light emitting element associated with the patterned electrical conductors is mounted onto the at least one substrate and is aligned with the at least one aperture. Additionally or alternatively, the at least one substrate and the at least one environmental protective element or the at least one space defining element are at least partially framed by a mounting assembly.

In accordance with yet another preferred embodiment of the present invention the mounting assembly accommodates a cable associated with a connector, the cable being coupled to the patterned electrical conductors. Preferably, the at least one architectural surface includes a plurality of surface modules, and the cable and the connector of adjacent ones of the plurality of surface modules are in communication with each other. Additionally or alternatively, the mounting assembly includes a mullion.

In accordance with still another preferred embodiment of the present invention the building structure also includes communications functionality operative to govern operation of the electrical circuitry. Preferably, the communications functionality includes at least one data server and at least one power supply which provides power to the electrical circuitry.

In accordance with a further preferred embodiment of the present invention the the at least one substrate includes a plurality of stacked layers of substrates, each including electrical circuitry coupled to at least one electrical component. Preferably, the plurality of stacked layers of substrates includes at least one substrate including at least one light emitting component and at least one other substrate including at least one temperature governing component. Additionally or alternatively, the plurality of stacked layers of substrates includes at least one substrate including at least one light emitting component and at least one other substrate including at least one audio component. As a further alternative, the plurality of stacked layers of substrates includes at least one substrate including at least one light emitting component and at least one other substrate including at least one energy collection and storage element operative to provide electrical power. As yet a further alternative, the plurality of stacked layers of substrates includes at least two substrates each including at least one light emitting component.

There is also provided in accordance with a further preferred embodiment of the present invention a method of manufacturing an architectural surface for a building structure, the method including providing at least one substrate which is at least one of transparent and flexible, forming electrical circuitry including patterned electrical conductors and at least one electrical component onto the at least one substrate and employing the at least one substrate having the electrical circuitry formed thereon as at least part of the architectural surface.

In accordance with a preferred embodiment of the present invention the forming includes printing the patterned electrical conductors onto the at least one substrate. Preferably, the forming includes digitally printing the patterned electrical conductors onto the at least one substrate.

In accordance with another preferred embodiment of the present invention the method also includes, following the forming, mounting the at least one electrical component onto the at least one substrate in communication with the patterned electrical conductors. Preferably the mounting includes adhering the at least one electrical component to the at least one substrate by a polysulfide adhesive.

In accordance with yet another preferred embodiment of the present invention the method also includes following the forming, mounting the at least one substrate in a mounting assembly. Preferably, the method also includes, prior to the providing, removing existing architectural elements from the architectural surface.

### BRIEF DESCRIPTION OF THE DRAWINGS

The present invention will be understood and appreciated more fully from the following detailed description, taken in conjunction with the drawings in which:

FIG. 1 is a simplified pictorial illustration of a building including a curtain wall structure constructed and operative in accordance with a preferred embodiment of the present invention;

FIG. 2 is a simplified pictorial illustration of the interior of a building including an architectural surface constructed and operative in accordance with a preferred embodiment of the present invention;

FIG. 3 is a simplified pictorial illustration of a temporary building structure including architectural surfaces constructed and operative in accordance with a preferred embodiment of the invention;

FIG. 4 is a simplified pictorial illustration of the interior of a building having architectural surfaces constructed and operative in accordance with another preferred embodiment of the invention;

FIG. 5 is a simplified pictorial illustration of retrofitting an existing building structure in accordance with a preferred embodiment of the present invention;

FIG. 6 is a simplified pictorial illustration of retrofitting an existing building structure in accordance with another preferred embodiment of the present invention;

FIG. 7 is a simplified pictorial illustration of retrofitting an existing building structure in accordance with yet another preferred embodiment of the present invention; and

FIG. 8 is a simplified illustration of methods of manufacturing architectural surface modules in accordance with embodiments of the present invention.

### DETAILED DESCRIPTION OF PREFERRED EMBODIMENTS

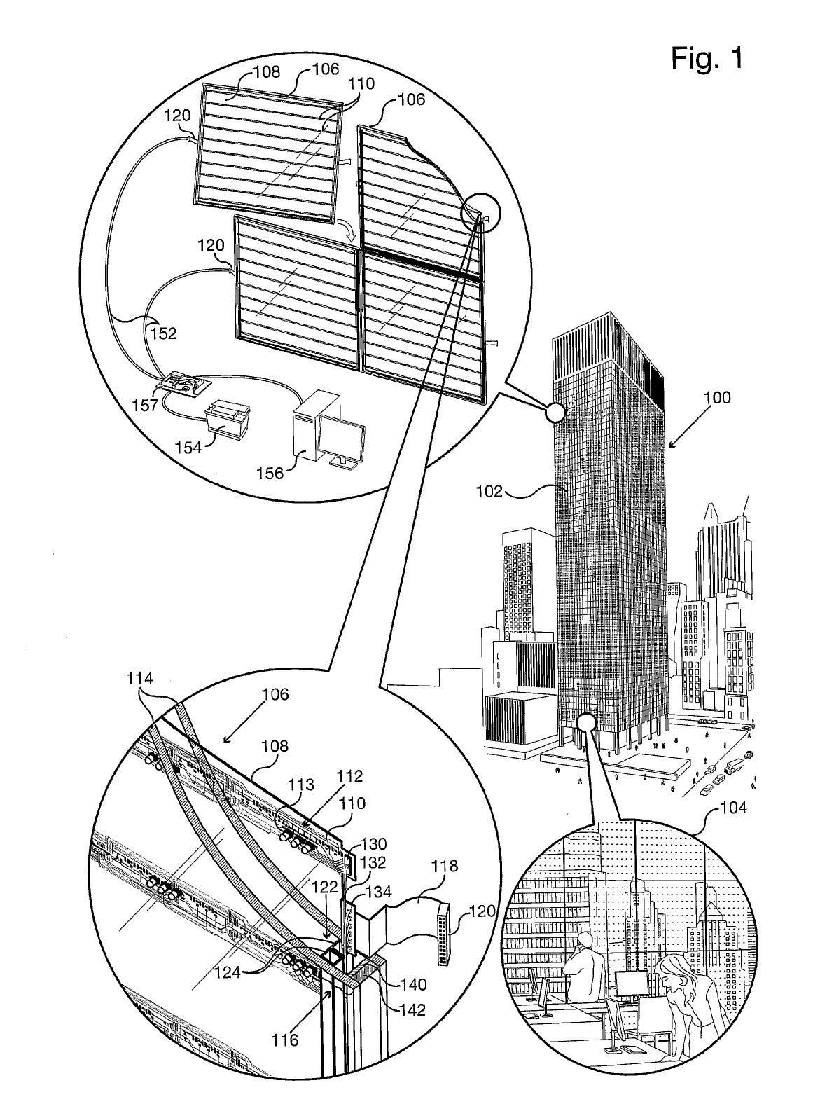

Reference is now made to FIG. 1, which is a simplified pictorial illustration of a building including a curtain wall structure constructed and operative in accordance with a preferred embodiment of the present invention. As shown in FIG. 1, there is provided a building structure 100, including a curtain wall 102 which may be installed generally in a conventional manner but is constructed and operative to provide a visually sensible image surface when viewed from the outside and preferably is highly transparent when viewed from the inside, in accordance with a preferred embodiment of the present invention, as seen at reference number 104. Throughout the description and claims, the term “highly transparent” refers to transparency of 70% or more.

In accordance with a preferred embodiment of the present invention, the curtain wall 102 comprises a multiplicity of curtain wall modules 106. Each curtain wall module 106 preferably comprises a substrate 108, which is preferably flexible and is typically a polyester film, such as MYLAR®, TETORON® or other TEIJIN® films commercially available from DuPont Inc., though any other suitable substrate, such as polyamide films may be utilized. Alternatively, a rigid substrate such as glass may be employed.

Electrical conductors 110 are printed onto substrate 108, preferably by means of conductive ink or by any other suitable means. Preferably, the substrate 108 is generally transparent to visible light. Alternatively, the substrate 108 may be translucent or opaque. Preferably, the conductive ink is PI-2000, commercially available from Dow-Corning of Midland, Mich., USA. Any suitable type of conductor, such as other conductive inks and transparent conductive inks, may also be used.

In accordance with a preferred embodiment of the invention, clusters 112 of variously colored Light Emitting Diodes (LEDs), preferably RGB LEDs, such as discrete LEDs commercially available from Bivar Inc. of Irvine, Calif., USA under catalog designator 3RC, or other light emitting elements 113 are mounted onto substrate 108 at suitable spatial intervals therealong in electrical communication with electrical conductors 110. Preferably, an electrically conductive adhesive, such as Electrically Conductive Isotropic Adhesive 3880, commercially available from Henkel Loctite Corporation of Rocky Hills, Conn., USA, is employed for this purpose. The electrical conductors 110 preferably supply electrical power to the clusters 112 and may also provide control information thereto.

Preferably the substrate 108 bearing the conductors 110 and the clusters 112 is sealingly encased between a pair of generally parallel glass or other transparent sheets 114. A peripheral mounting and sealing rim assembly 116 joins the transparent sheets and the substrate 108 and accommodates a flat cable 118 which is coupled to conductors 110 and to a power and/or data connector 120.

As seen in FIG. 1, the peripheral mounting and sealing rim assembly 116 preferably comprises a spacer subassembly 122 which includes a pair of peripheral rim elements 124, each attached to a corresponding transparent sheet 114 by an adhesive, preferably a polysulfide adhesive, such as Thiover, commercially available from Fenzi SpA of Tribiano, Italy. The substrate 108 is preferably retained taut by frictional engagement thereof between adjacent peripheral rim elements 124.

Conductors 110, connected to clusters 112, are coupled to edge connectors 130, which in turn are coupled via cables 132 to a flat cable connector 134 on flat cable 118. One or more flat cables 118 thus provide power and/or data connections for each curtain wall module 106 and extend through a suitable slit (not shown) formed in a peripheral edge element 140 to power and/or data connector 120. Peripheral edge element 140 is preferably spaced from spacer subassembly 122, thereby to define a channel for accommodating cables 132 and flat cable connector 134. A silicon environmental seal 142 is preferably provided on the outside periphery of peripheral edge element 140.

The various curtain wall modules 106 are preferably mounted in a conventional curtain wall facade system mounting arrangement (not shown) and the power and/or data connectors 120 of adjacent modules 106 are electrically coupled to each other. Preferably, along one edge of a building there is provided data and/or power cabling 152 which interconnects to the power and/or data connectors 120 of modules 106 adjacent thereto and thus provides power and/or data connections for the entire curtain wall of a building.

The data and/or power cabling 152 is preferably coupled to a suitable power supply 154 and to a data server 156 via interface circuitry 157 for driving the clusters 112. A non-limiting example of data and/or power cabling system which provides this functionality appears in PCT Published Patent Application WO 2004/114268, the description of which is hereby incorporated by reference. It is appreciated that the various cables and wires used for purposes of the present invention may be replaced by wireless components.

It is appreciated that the curtain wall 102 described hereinabove may be employed in alternative embodiments as shown and described hereinbelow. The electrical conductors 110 may be coupled to one or more of light and/or sound transducers, temperature governing elements, environmental sensors, motion sensors, pressure sensors, climate control elements and energy collection and storage elements. Additionally, suitable packaging may be employed to mount the curtain wall 102 described hereinabove on any suitable architectural surface, including internal wall surfaces, ceilings and floors.

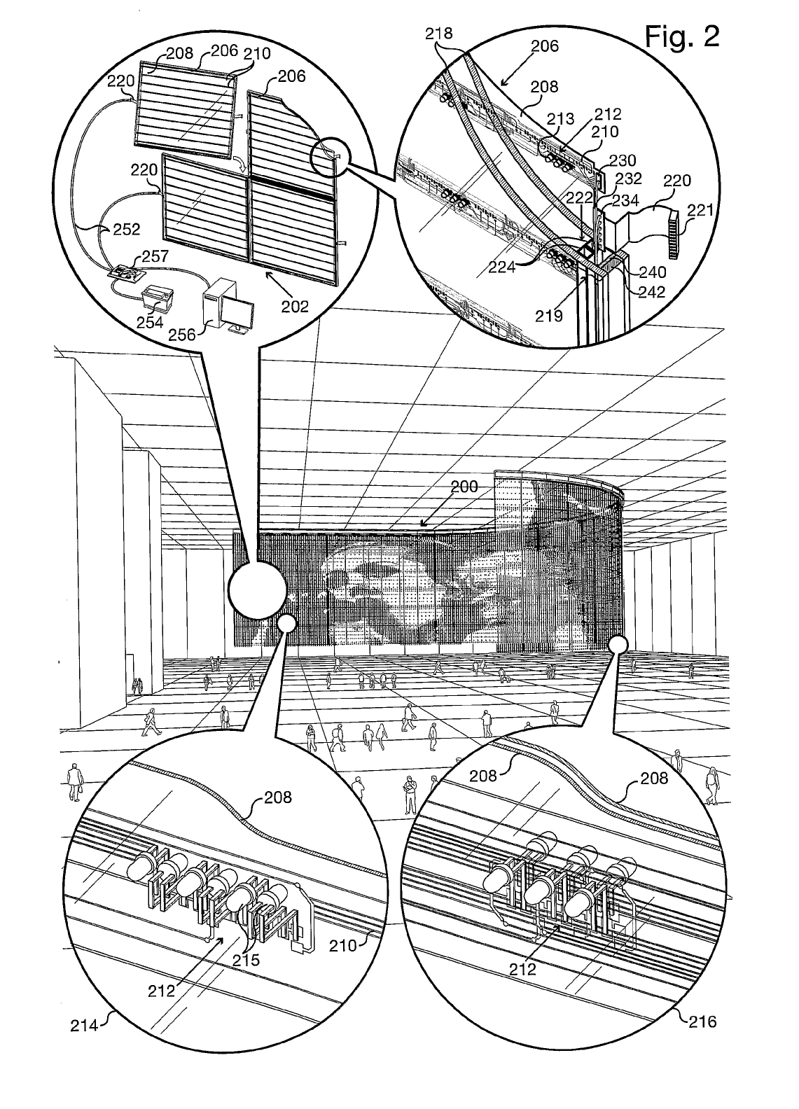

Reference is now made to FIG. 2, which is a simplified pictorial illustration of an architectural surface of an interior of a building constructed and operative in accordance with a preferred embodiment of the present invention. As shown in FIG. 2, there is provided a curved curtain display structure 200, preferably including a rigid curtain assembly 202 which may be installed generally in a conventional manner, as by suspension from above, but is constructed and operative to provide at least one and preferably two visually sensible image surfaces when viewed from opposing sides. In accordance with one embodiment of the invention, an identical image may be seen from either side of the display structure 200. Alternatively, different images, such as different video images, may be simultaneously provided on opposite sides of the display structure. The display structure may be transparent, translucent or opaque or may include sections of differing degrees of transparency or opacity.

In accordance with a preferred embodiment of the present invention, the rigid curtain assembly 202 comprises a multiplicity of modules 206. Each module 206 preferably comprises a substrate 208, which is preferably flexible and is typically a polyester film, such as MYLAR®, TETORON® or other TEIJIN® films commercially available from DuPont Inc., though any other suitable substrate, such as polyamide films may be utilized. Alternatively, a rigid substrate, such as glass, may be employed.

Electrical conductors 210 are printed onto substrate 208, preferably by means of conductive ink or by any other suitable means. The substrate 208 is may be transparent, translucent or opaque or may include sections of differing degrees of transparency or opacity. Preferably, the conductive ink is PI-2000, commercially available from Dow-Corning of Midland, Mich., USA. Any suitable type of conductor, such as other conductive inks and transparent conductive inks, may also be used.

In accordance with a preferred embodiment of the invention, clusters 212 of variously colored LEDs, preferably RGB LEDs, or other light emitting elements 213 are mounted onto substrate 208 at suitable spatial intervals therealong in electrical communication with electrical conductors 210. Preferably, an electrically conductive adhesive, such as Electrically Conductive Isotropic Adhesive 3880, commercially available from Henkel Loctite Corporation of Rocky Hills, Conn., USA, is employed for this purpose. The electrical conductors 210 preferably supply electrical power to the clusters 212 and may also provide control information thereto.

Clusters 212 are preferably SMD LED clusters, such as SMD LED clusters commercially available from Bivar, Inc. of Irvine, Calif., USA under catalog designator SM1210RGB. Similar SMD clusters may be useful also in the embodiment of FIG. 1 and in other embodiments of the present invention.

In accordance with a preferred embodiment of the present invention, clusters 212 include LEDs 215 which face in opposite directions, as seen in FIG. 2 at reference numeral 214, in order to provide displays on opposite sides of the curtain display structure 200. Alternatively, two substrates 208 may be arranged back-to-back, such that the clusters 212 thereof provide a display on both opposite sides of the curtain display structure as shown at reference numeral 216.

In a case where two different images are displayed on opposite sides of the display structure 200, different electrical conductors 210 are provided for each side of the display. The electrical conductors 210 may be printed on both sides of the substrate 208 such as in a case where each side displays a different image, or alternatively two substrates 208, each printed on a single side thereof, may be used back-to-back as shown at reference numeral 216.

Preferably, the substrate 208, bearing the conductors 210 and the clusters 212, is sealingly encased between a pair of generally parallel glass or other transparent sheets 218. A peripheral mounting and sealing rim assembly 219 joins the transparent sheets 218 and the substrate 208 and accommodates a flat cable 220 which is coupled to conductors 210 and to a power and/or data connector 221.

As seen in FIG. 2, the peripheral mounting and sealing rim assembly 219 preferably comprises a spacer subassembly 222 which includes a pair of peripheral rim elements 224, each attached to a corresponding transparent sheet 218 by an adhesive, preferably a polysulfide adhesive, such as Thiover, commercially available from Fenzi of Tribiano, Italy. The substrate 208 is preferably retained taut by frictional engagement thereof between adjacent peripheral rim elements 224.

Conductors 210, connected to clusters 212, are coupled to edge connectors 230, which in turn are coupled via cables 232 to a flat cable connector 234 on flat cable 220. One or more flat cables 220 thus provide power and/or data connections for each panel like curtain module 206 and extend through a suitable slit (not shown) formed in a peripheral edge element 240 to power and/or data connector 221. Peripheral edge element 240 is preferably spaced from spacer subassembly 222, thereby to define a channel for accommodating cables 232 and flat cable connector 234. A silicon environmental seal 242 is preferably provided on the outside periphery of peripheral edge element 240. However, when the display structure 200 is mounted on an interior architectural surface, as shown in the present embodiment, the silicon environmental seal may be obviated.

The various modules 206 may be mounted in any suitable conventional or non-conventional mounting arrangement and the power and/or data connectors 221 of adjacent modules 206 are electrically coupled to each other. Preferably there is provided data and/or power cabling 252 which interconnects to the power and/or data connectors 221 of modules 206 adjacent thereto and thus provides power and/or data connections for the entire display structure 200.

The data and/or power cabling 252 is preferably coupled to a suitable power supply 254 and to a data server 256 via interface circuitry 257 for driving the clusters 212. A non-limiting example of data and/or power cabling system which provides this functionality appears in PCT Published Patent Application WO 2004/114268, the description of which is hereby incorporated by reference. It is appreciated that the various cables and wires used for purposes of the present invention may be replaced by wireless components.

It is appreciated that the display structure 200 described hereinabove may be employed in alternative embodiments as shown and described hereinbelow. The electrical conductors 210 may be coupled to one or more of light and/or sound transducers, temperature governing elements, environmental sensors, motion sensors, pressure sensors, climate control elements and energy collection and storage elements. Additionally, suitable packaging may be employed to mount the display structure 200 described hereinabove on any suitable architectural surface, including internal wall surfaces, ceilings and floors.

It is further appreciated that in an alternative embodiment, two different functionalities may be provided on opposite sides of the curtain display structure 200. In such a case, different electrical conductors 210 are provided for each of the sides of the display structure 200. The electrical conductors 210 may be printed on either side of the substrate 208, or alternatively two substrates 208, each printed on a single side thereof, may be used back-to-back. Such back-to-back arrangement may also be employed in the embodiment described hereinabove with reference to FIG. 1 and in the embodiments described hereinbelow.

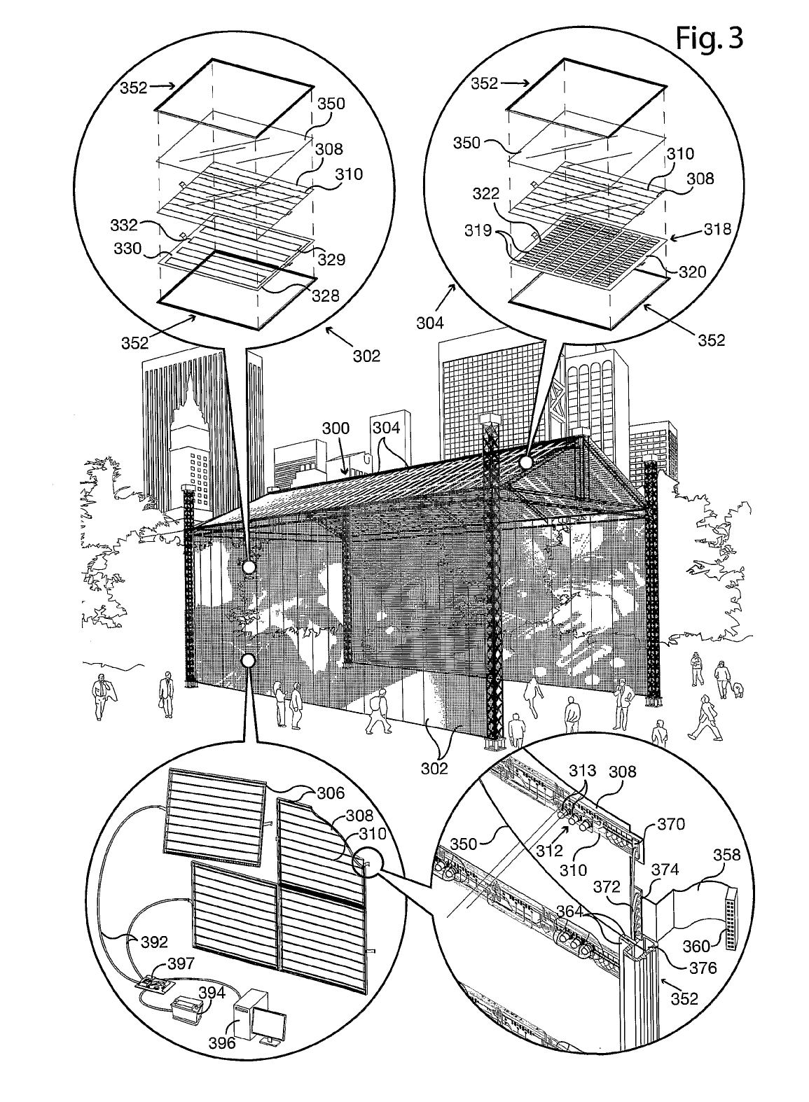

Reference is now made to FIG. 3, which is a simplified pictorial illustration of a temporary building structure including architectural surfaces constructed and operative in accordance with a preferred embodiment of the present invention. As shown in FIG. 3, there is provided a temporary building structure 300, such as a tent, preferably including a plurality of assemblies 302, serving as tent walls, and a plurality of assemblies 304, serving as tent roof panels. Assemblies 302 and 304 preferably are constructed and operative to provide at least one and preferably two visually sensible image surfaces when viewed from either side. Additionally or alternatively, assemblies 302 and 304 are constructed and operative to provide at least one temperature control surface.

In accordance with one embodiment of the invention, an identical image may be seen from either side of the assemblies 302 and 304. Alternatively, different images, such as different video images, may be simultaneously provided on opposite sides of the assemblies, or an image may be provided only on a single surface of the assemblies 302 and 304.

Assemblies 304 preferably are constructed and operative to serve as photovoltaic panels which could provide electrical power for operating the displays on assemblies 302 and 304 and other electrical devices, thereby providing an at least partially autonomous, electrically self-sustaining, shelter having integrated electrical display and temperature control capabilities.

In accordance with a preferred embodiment of the present invention, the assembly 302 and 304 comprise a plurality of modules 306. Each module 306 preferably comprises a substrate 308, which is preferably flexible and is typically a polyester film, such as MYLAR®, TETORON® or other TEIJIN® films commercially available from DuPont Inc., though any other suitable substrate, such as a polyamide film may be utilized. Alternatively, a rigid substrate such as glass may be employed.

Electrical conductors 310 are printed onto substrate 308, preferably by means of conductive ink or by any other suitable means. Preferably, the substrate 308 is generally transparent to visible light. Alternatively, the substrate 308 may be translucent or opaque. Preferably, the conductive ink is PI-2000, commercially available from Dow-Corning commercially available from Dow-Corning of Midland, Mich., USA. Any suitable type of conductor, such as other conductive inks and transparent conductive inks, may also be used.

In accordance with a preferred embodiment of the invention, clusters 312 of variously colored LEDs, preferably RGB LEDs, or other light emitting elements 313 are mounted onto substrate 308 at suitable spatial intervals therealong in electrical communication with electrical conductors 310. Preferably, an electrically conductive adhesive, such as Electrically Conductive Isotropic Adhesive 3880, commercially available from Henkel Loctite Corporation of Rocky Hills, Conn., USA, is employed for this purpose. The electrical conductors 310 preferably supply electrical power to the clusters 312 and may also provide control information thereto.

Clusters 312 are preferably SMD LED clusters, composed of LEDs such as Discrete LEDs commercially available from Bivar, Inc. of Irvine, Calif., USA under catalog designator 3RC. Alternatively, SMD LEDs, such as SMD LEDs commercially available from Bivar, Inc. of Irvine, Calif., USA under catalog designator SM1210RGB, may be employed.

In accordance with a preferred embodiment of the present invention, clusters 312 include LEDs which face in opposite directions, in a similar manner to that shown at reference numerals 214 and 216 (FIG. 2), in order to provide displays on opposite sides of the assemblies 302 and 304. Alternatively, two substrates 308 may be arranged back-to-back, such that the clusters 312 thereof provide a display on both opposite sides of the curtain assemblies 302 and 304.

In a case where two different images are displayed on either side of the assemblies 302 and 304, different electrical conductors 310 are provided for each side of the display. The electrical conductors 310 may be printed on both sides of the substrate 308 such as in a case where each side displays a different image, or alternatively two substrates 308, each printed on a single side thereof, may be used back-to-back.

In accordance with a preferred embodiment of the present invention, assembly 304 comprises a plurality of photovoltaic modules 318. Each of modules 318 comprises photovoltaic units 319, such as Powerfilm 20w commercially available from Silicon Solar Inc. of Bainbridge, N.Y., USA under catalog designator R15-1200, mounted on a substrate 320, which is preferably flexible and is typically a polyester film, such as MYLAR®, TETORON® or other TEIJIN® films commercially available from DuPont Inc., though any other suitable substrate, such as polyamide films may be utilized. Alternatively, a rigid substrate such as glass may be employed.

The photovoltaic units 319 are interconnected by electrical conductors 322, which are preferably printed onto substrate 320, preferably by means of conductive ink or by any other suitable means. Preferably, the substrate 320 is generally transparent to visible light. Alternatively, the substrate 320 may be translucent or opaque. Preferably, the conductive ink is PI-2000, commercially available from Dow-Corning of Midland, Mich., USA. Any suitable type of conductor, such as other conductive inks and transparent conductive inks, may also be used. The electrical conductors 322 preferably obtain electrical power from the photovoltaic units 319 and may also provide control information thereto.

In accordance with a preferred embodiment of the present invention, assembly 302 comprises a plurality of heating modules 328. Each of modules 328 comprises a heating element 329, such as a Thick Film Heating Element, commercially available from Tempco Electric Heater Corporation of Wood Dale, Ill., USA, mounted on a substrate 330, which is preferably flexible and is typically a polyester film, such as MYLAR®, TETORON® or other TEIJIN® films commercially available from DuPont Inc., though any other suitable substrate, such as polyamide films may be utilized. Alternatively, a rigid substrate such as glass may be employed.

The heating element 329 is interconnected by electrical conductors 332, which are preferably printed onto substrate 330, preferably by means of conductive ink or by any other suitable means. Preferably, the substrate 330 is generally transparent to visible light. Alternatively, the substrate 330 may be translucent or opaque. Preferably, the conductive ink is PI-2000, commercially available from Dow-Corning of Midland, Mich., USA. Any suitable type of conductor, such as other conductive inks and transparent conductive inks, may also be used. The electrical conductors 332 preferably provide electrical power to the heating element 329 and may also provide control information thereto.

Preferably, each of substrates 308, 320 and 330, respectively bearing the conductors 310, 322 and 332 and the clusters 312, photovoltaic units 319 and heating elements 329 is sealed to another sheet 350, which is preferably flexible and transparent and is typically formed of a polyester film, such as MYLAR®. The substrates 308, 320 and 330 and the sealing sheet 350 are preferably joined so as to encase the conductors 310, 322 and 332 and the clusters 312, photovoltaic units 319 and heating elements 329 between the substrates 308, 320 and 330 and the sealing sheet 350.

A peripheral mounting and sealing rim assembly 352 joins the substrate 308, substrate 320 or substrate 330 and its encasing transparent sheet 350 at their respective peripheries and accommodates a flat cable 358 which is coupled to respective conductors 310, 322 and 332 and to a power and/or data connector 360.

As seen in FIG. 3, the peripheral mounting and sealing rim assembly 352 preferably comprises a pair of joined peripheral rim elements 364. The substrate 308, 320 or 330 and the sealing sheet 350 are preferably retained taut by frictional engagement thereof between adjacent peripheral rim elements 364. In one preferred embodiment of the present invention, the sealing rim assembly 352 may be formed of a transparent or translucent plastic, which may be rigid or flexible.

Conductors 310, 322 and 332, respectively connected to clusters 312, photovoltaic units 319 and heating elements 329, are coupled to edge connectors 370, which in turn are coupled via cables 372 to a flat cable connector 374. One or more flat cables 358 thus provide power and/or data connections for each module 306, photovoltaic module 318 and heating module 328 and extend through a suitable slit (not shown) formed in a peripheral edge element (not shown) to power and/or data connector 360. Peripheral rim elements 364 together define a channel 376 for accommodating cables 372 and flat cable connector 374.

The various modules 306, photovoltaic modules 318 and heating modules 328 are preferably mounted in a lightweight suspension mounting arrangement (not shown), and the power and/or data connectors 360 of adjacent ones of modules 306, 318 and 328 are electrically coupled to each other. Preferably along one edge of curtain assemblies 302 and 304 there is provided data and/or power cabling 392 which is connected to the power and/or data connectors 360 of modules 306, 318 and 328 adjacent thereto and thus provides power and/or data connections for the entire structure.

The data and/or power cabling 392 is preferably coupled to a suitable power supply 394 and to a data server 396 via interface circuitry 397 for driving the clusters 312, photovoltaic units 319 and heating elements 329. A non-limiting example of a data and/or power cabling system which provides this functionality appears in PCT Published Patent Application WO 2004/114268, the description of which is hereby incorporated by reference. It is appreciated that the various cables and wires used for purposes of the present invention may be replaced by wireless components.

It is a particular feature of the present invention, which is applicable not only to the embodiment of FIG. 3, but also to the other embodiments shown and described herein, that stacked layers of electrical devices may readily be incorporated into modules which can be combined to define architectural surfaces in accordance with the present invention.

In accordance with the present invention, a layer having electrical conductors deposited thereon may be combined with one or more of a light and/or sound generating layer, a temperature governing layer and an environmental sensor, and specifically the curtain wall modules, photovoltaic modules and heating modules described hereinabove may be combined in any appropriate way by layering of substrates thereof within a single peripheral mounting and sealing rim assembly 352. Alternatively, several layers of electrical conductors could be deposited on either one or two sides of the substrate to stack layers of electrical devices. The provision of these electrical devices in a stacked modular form, as described herein, greatly enhances the cost effectiveness, space efficiency and utility of such devices in an architectural context.

It is appreciated that the photovoltaic modules and heating modules described hereinabove may also be employed in the embodiments of FIG. 1 and FIG. 2 as well as in other embodiments of the present invention.

It is further appreciated that assemblies 302 and 304 described hereinabove may be employed in various alternative embodiments. The electrical conductors 310, 322 and 332 may be coupled to one or more of light and/or sound transducers, temperature governing elements, environmental sensors, motion sensors, pressure sensors, climate control elements and energy collection and storage elements.

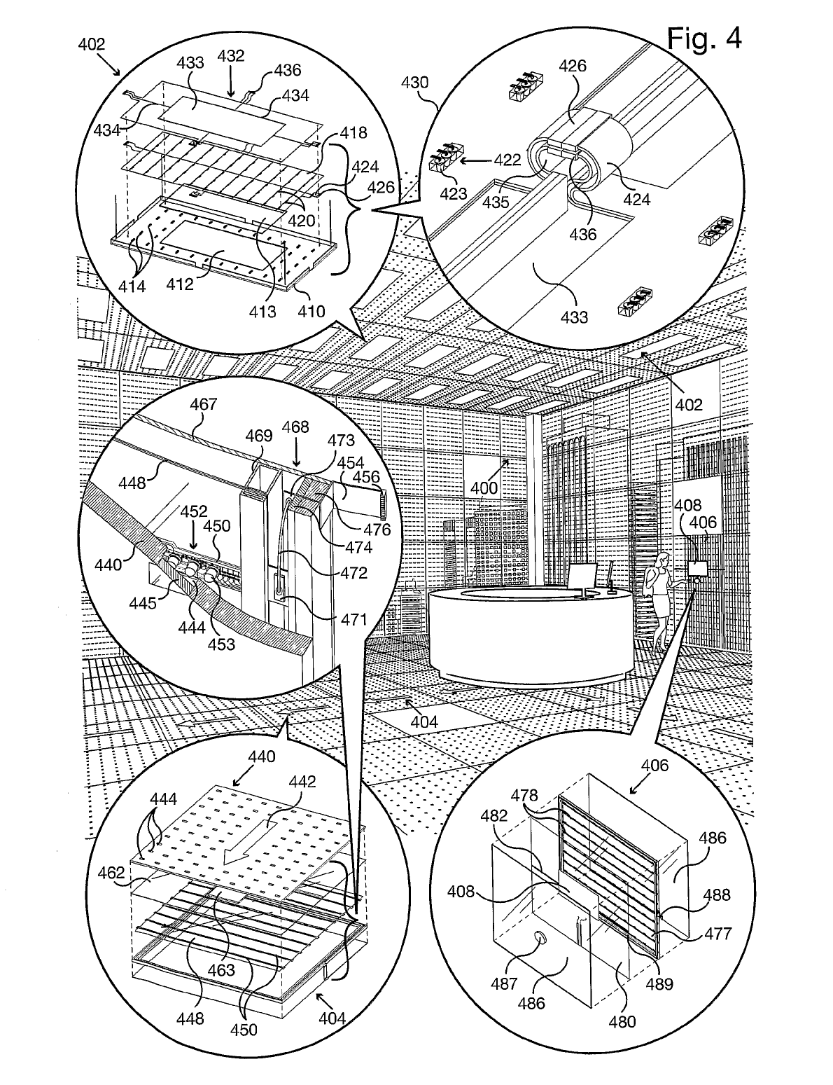

Reference is now made to FIG. 4, which is a simplified pictorial illustration of a building structure including interior architectural surfaces constructed and operative in accordance with a preferred embodiment of the present invention. As shown in FIG. 4, a building structure 400 preferably includes a plurality of rigid ceiling assemblies 402 and a plurality of rigid floor assemblies 404, as well as a plurality of wall panels 406 which may include one or more high resolution display panels 408.

Rigid ceiling assemblies 402 preferably are constructed and operative to provide a visually sensible image/lighting surface. As seen in FIG. 4, rigid ceiling assemblies 402 preferably each comprise a suspended cover panel 410 which may have a central aperture 412 for accommodating a transparent panel 413. The suspended cover panel 410 preferably is formed, as by CNC machining, with a multiplicity of apertures 414. Alternatively, cover panel 410 may be formed of a plastic sheet, and may be produced by injection molding or press molding.

Disposed behind suspended cover panel 410 and preferably supported thereby is a substrate 418, which is preferably flexible and is typically a polyester film, such as MYLAR®, TETORON® or other TEIJIN® films commercially available from DuPont Inc., though any other suitable substrate, such as polyamide film may be utilized. Alternatively, a rigid substrate such as glass may be employed.

Electrical conductors 420 are printed onto substrate 418, preferably by means of conductive ink or by any other suitable means. Preferably, the substrate 418 is generally transparent to visible light. Alternatively, the substrate 418 may be translucent or opaque. Preferably, the conductive ink is PI-2000, commercially available from Dow-Corning of Midland, Mich., USA. Any suitable type of conductor, such as other conductive inks and transparent conductive ink may also be used.

In accordance with a preferred embodiment of the invention, clusters 422 of variously colored LEDs, preferably RGB LEDs, or other light emitting elements 423 are mounted onto substrate 418 at suitable spatial intervals therealong in electrical communication with electrical conductors 420. Preferably, an electrically conductive adhesive, such as Electrically Conductive Isotropic Adhesive 3880, commercially available from Henkel Loctite Corporation of Rocky Hills, Conn., USA, is employed for this purpose. The electrical conductors 420 preferably supply electrical power to the clusters 422 and may also provide control information thereto. Preferably the clusters 422 are each aligned with one of apertures 414 in the suspended cover panel 410, so as to be visible therethrough.

Preferably the substrate 418 bearing the conductors 420 and the clusters 422 is associated with a plurality of flat cables 424, each coupled to conductors 420 and to a power and/or data connector 426. The power and/or data connectors 426 of adjacent substrates 418 of corresponding adjacent rigid ceiling assemblies 402 may be interconnected via one or more of the flat cables 424 and the power and/or data connectors 426, it being appreciated that not all of the power and/or data connectors 426 need necessarily be interconnected, thus accommodating incomplete grid type arrangements of rigid ceiling assemblies 402, as shown at reference numeral 430.

Disposed preferably behind substrate 418 there is preferably formed a modular electrical panel 432, including a modular electrical device 433, here shown as a flat lighting device such as an OLED or EL light module, such as an HBC EL Lamp, commercially available from Rogers Corporation of Chandler, Ariz., USA, under catalog designator Durel 3 HBC-604. The modular electrical device 433 is connected to electrical circuitry 434, preferably having a plurality of connection points, which is mounted on the modular electrical panel 432.

Alternatively, the modular electrical device 433 may be a flat speaker or other audio transducer, such as a SolidDrive X audio transducer, commercially available from Induction Dynamics Corporation of Overland Park, Kans., USA or a Sisonic audio microphone, commercially available from Knowles Acoustics of Itasca, Ill., USA under catalog designator SPM0103nd3, a heating or cooling element, such as a Thick Film Heating Element, commercially available from Tempco Electric Heater Corporation of Wood Dale, Ill., USA, or a sensor or detector, such as an ambient light sensor commercially available from Vishay Intertechnology Inc. of Malvern, Pa., USA, under catalog designator TEMT6000.

The electrical circuitry 434 of the modular electrical device 432 is associated with a plurality of flat cables 435, each coupled to a power and/or data connector 436. The power and/or data connectors 436 of adjacent rigid ceiling assemblies 402 may be interconnected via one or more of the flat cables 435 and the power and/or data connectors 436, it being appreciated that not all of the power and/or data connectors 436 need be interconnected, thus accommodating incomplete grid type arrangements of rigid ceiling assemblies 402.

It is appreciated that the circuitry 434 and conductors 420 may be independent of each other, and therefore provide a modular system. It is further appreciated that notwithstanding that not all the power and/or data connectors 436 need be interconnected, due to the provision of possibly redundant connection points, power may reach all the panels that are connected to a given panel. Thus, the resulting arrangement is preferably a complete grid type arrangement.

Rigid floor assemblies 404 preferably are constructed and operative to provide a visually sensible image and/or lighting surface. As seen in FIG. 4, rigid floor assemblies 404 preferably each comprise a rigid floor panel 440 which may have a central aperture 442 for accommodating a transparent floor panel (not shown). The rigid floor panel 440 preferably is formed, as by CNC machining, with a multiplicity of apertures 444, each of which is preferably sealed by a transparent sealing element 445.

Disposed below rigid floor panel 440 and preferably supported thereby is a substrate 448, which is preferably flexible and is typically a polyester film, such as MYLAR®, TETORON® or other TEIJIN® films commercially available from DuPont Inc., though any other suitable substrate, such as polyamide films may be utilized., Alternatively, a rigid substrate such as glass may be employed.

Electrical conductors 450 are printed onto substrate 448, preferably by means of conductive ink or by any other suitable means. Preferably, the substrate 448 is generally transparent to visible light. Alternatively, the substrate 448 may be translucent or opaque. Preferably, the conductive ink is PI-2000, commercially available from Dow-Corning of Midland, Mich., USA. Any suitable type of conductor, such as other conductive inks and transparent conductive ink, may also be used.

In accordance with a preferred embodiment of the invention, clusters 452 of variously colored LEDs, preferably RGB LEDs, or other light emitting elements 453 are mounted onto substrate 448 at suitable spatial intervals therealong in electrical communication with electrical conductors 450. Preferably, an electrically conductive adhesive, such as Electrically Conductive Isotropic Adhesive 3880, commercially available from Henkel Loctite Corporation of Rocky Hills, Conn., USA, is employed for this purpose. The electrical conductors 450 preferably supply electrical power to the clusters 452 and may also provide control information thereto. Preferably the clusters 452 are each aligned with one of apertures 444 in the rigid floor panel 440, so as to be visible therethrough.

Preferably the substrate 448 bearing the conductors 450 and the clusters 452 is associated with a plurality of flat cables 454, each coupled to conductors 450 and to a power and/or data connector 456. The power and/or data connectors 456 of adjacent substrates 448 of corresponding adjacent rigid floor assemblies 404 may be interconnected via one or more of the flat cables 454 and the power and/or data connectors 456.

Disposed preferably behind substrate 448 there is preferably an additional substrate 462, including a modular electrical device 463, here shown as flat lighting device such as an OLED or EL light module, such as an HBC EL Lamp, commercially available from Rogers Corporation of Chandler, Ariz., USA, under catalog designator Durel 3 HBC-604.

Alternatively, the modular electrical device 463 may be a flat speaker or other audio transducer, such as a SolidDrive X audio transducer, commercially available from Induction Dynamics Corporation of Overland Park, Kans., USA or a Sisonic audio microphone, commercially available from Knowles Acoustics of Itasca, Ill., USA under catalog designator SPM0103nd3, a heating or cooling element, such as a Thick Film Heating Element, commercially available from Tempco Electric Heater Corporation of Wood Dale, Ill., USA, or a sensor or detector, such as an ambient light sensor commercially available from Vishay Intertechnology Inc. of Malvern, Pa., USA, under catalog designator TEMT6000.

The modular electrical device 463 is associated with a plurality of flat cables (not shown), each coupled to a power and/or data connector (not shown). It is appreciated that circuitry connected to modular electrical device 463 and conductors 450 may be independent of each other, and therefore provide a modular system. It is further appreciated that notwithstanding that not all the power and/or data connectors 456 modular electrical devices 463 need be interconnected, due to the provision of possibly redundant connection points, power may reach all the panels that are connected to a given panel. Thus, the resulting arrangement is preferably a complete grid type arrangement.

In the example shown in FIG. 4, the modular electrical device comprises arrow shaped lighting elements, which may be used to direct people out of the building structure 400, in an emergency. It is appreciated that the modular electrical device may be employed to provide any other type of informational or decorative sign or visible indication.

As seen in FIG. 4, preferably the substrate 448 bearing the conductors 450 and the clusters 452 is sealingly encased between rigid panel 440 and a back encasing panel 467, which is suited to the building onto which the module is mounted. A peripheral mounting and sealing rim assembly 468 joins the rigid panel 440, the substrate 448 and the back encasing panel 467 and accommodates the flat cable 465.

As seen in FIG. 4, the peripheral mounting and sealing rim assembly 468 preferably comprises a spacer subassembly 469 which includes a pair of peripheral rim elements 470, attached to rigid panel 440 and back encasing panel 467 by an adhesive, preferably a polysulfide adhesive, such as Thiover, commercially available from Fenzi SpA of Tribiano, Italy. The substrate 448 is preferably retained taut by frictional engagement thereof between adjacent peripheral rim elements 470.

Conductors 450, connected to clusters 452, are coupled to edge connectors 471, which in turn are coupled via cables 472 to a flat cable connector 473 on flat cable 465. One or more flat cables 465 thus provide power and/or data connections for each rigid floor module 404 and extend through a suitable slit (not shown) formed in a peripheral edge element 474 to the power and/or data connector. Peripheral edge element 474 is preferably spaced from spacer subassembly 469, thereby to define a channel for accommodating cables 472 and flat cable connector 473. A silicon environmental seal 476 is preferably provided on the outside periphery of peripheral edge element 474.

The rigid ceiling assemblies 402 and rigid floor assemblies 404 are preferably mounted in a conventional manner and the power and/or data connectors of adjacent ceiling and floor assemblies are electrically coupled to each other. Preferably along one edge of a ceiling and/or floor of a room there is provided data and/or power cabling (not shown) which interconnects to the power and/or data connectors and thus provides power and/or data connections for the architectural surface defined by the rigid ceiling assemblies and/or the rigid floor assemblies.

The data and/or power cabling is preferably coupled to a suitable power supply and to a data server, similar to power supply 154 and data server 156 described hereinabove with reference to FIG. 1. A non-limiting example of data and/or power cabling system which provides this functionality appears in PCT Published Patent Application WO 2004/114268, the description of which is hereby incorporated by reference. It is appreciated that the various cables and wires used for purposes of the present invention may be replaced by wireless components.

In accordance with a preferred embodiment of the present invention the panels 406 preferably are constructed and operative to provide a visually sensible image as well as an audibly sensible surface. As seen in FIG. 4, panels 406 preferably each comprise a first substrate 477, which is preferably flexible and is typically a polyester film, such as MYLAR®, TETORON® or other TEIJIN® films commercially available from DuPont Inc., though any other suitable substrate, such as polyamide films may be utilized. Alternatively, a rigid substrate such as glass may be employed.

Electrical conductors 478 are printed onto substrate 477, preferably by means of conductive ink or by any other suitable means. Preferably, the substrate 477 is generally transparent to visible light. Alternatively, the substrate 477 may be translucent or opaque. Preferably, the conductive ink is PI-2000, commercially available from Dow-Corning of Midland, Mich., USA. Any suitable type of conductor, such as other conductive inks and transparent conductive inks, may also be used.

In accordance with a preferred embodiment of the invention, clusters (not shown) of variously colored LEDs, preferably RGB LEDs, or other light emitting elements are mounted onto substrate 477 at suitable spatial intervals therealong in electrical communication with electrical conductors 478. Preferably, an electrically conductive adhesive, such as Electrically Conductive Isotropic Adhesive 3880, commercially available from Henkel Loctite Corporation of Rocky Hills, Conn., USA, is employed for this purpose. The electrical conductors 478 preferably supply electrical power to the clusters and may also provide control information thereto.

One or more of panels 406 may include a high resolution display portion, including a high resolution display panel 408, preferably an OLED display module, such as a KODAK NUVUE Display, commercially available from Kodak of Rochester, N.Y., USA under catalog designator AM550L. High resolution display panel 408 preferably is mounted on a second substrate 480 disposed behind or in front of substrate 477. Substrate 480 is preferably flexible and is typically a polyester film, such as MYLAR®, TETORON® or other TEIJIN® films commercially available from DuPont Inc., though any other suitable substrate, such as polyamide films may be utilized. Alternatively, a rigid substrate such as glass may be employed.

Electrical conductors 482 are printed onto substrate 480, preferably by means of conductive ink or by any other suitable means. Preferably, the substrate 480 is generally transparent to visible light. Alternatively, the substrate 480 may be translucent or opaque. Preferably, the conductive ink is PI-2000, commercially available from Dow-Corning of Midland, Mich., USA. Any suitable type of conductor, such as other conductive inks and transparent conductive ink, may also be used.

In accordance with a preferred embodiment of the present invention, one or more modular electrical devices, in addition to the OLED display module are also mounted onto substrate 480 at suitable locations thereon in electrical communication with electrical conductors 482. Preferably, an electrically conductive adhesive, such as Electrically Conductive Isotropic Adhesive 3880, commercially available from Henkel Loctite Corporation of Rocky Hills, Conn., USA, is employed for this purpose. The electrical conductors 482 preferably supply electrical power to the modular electrical devices and may also provide control information thereto.

As described hereinabove with reference to FIGS. 1-3, preferably the substrates 477 and 480, bearing the conductors 478 and 482 and the clusters and modular electrical devices mounted thereon, are sealingly encased between a pair of generally parallel glass or other transparent sheets 486. An audio transducer module 487, preferably an audio driver, commercially available from Induction Dynamics Corporation of Overland Park, Kans., USA, may be mounted onto one of sheets 486. Alternatively, audio transducer module 487 may include one or more microphones.

A peripheral mounting and sealing rim assembly (not shown), similar to peripheral mounting and sealing rim assembly 116 described hereinabove with reference to FIG. 1, joins transparent sheets 486 and substrates 477 and 480 and accommodates a pair of flat cables 488 and 489, which are respectively coupled to conductors 478 and 482 and to respective power and/or data connectors (not shown), in a similar manner to that described hereinabove with reference to FIGS. 1-3.

The various modules 406 are preferably mounted in a suitable mounting arrangement (not shown) and the power and/or data connectors of adjacent modules 406 are electrically coupled to each other. Preferably there is provided data and/or power cabling (not shown), similar to data and/or power cabling 152 described hereinabove with reference to FIG. 1, which interconnects to the power and/or data connectors of modules 406 adjacent thereto and thus provides power and/or data connections for the entire building structure shown in FIG. 4.

It is a particular feature of the present invention, which is applicable not only to the embodiment of FIG. 4, but also to the other embodiments shown and described herein, that stacked layers of electrical devices may readily be incorporated into modules which can be combined to define architectural surfaces in accordance with the present invention.

In accordance with the present invention, a layer having electrical conductors deposited thereon may be combined with one or more of a light and/or sound generating layer, a temperature governing layer and an environmental sensor. The provision of these electrical devices in a stacked modular form, as described herein, greatly enhances the cost effectiveness, space efficiency and utility of such devices in an architectural context.

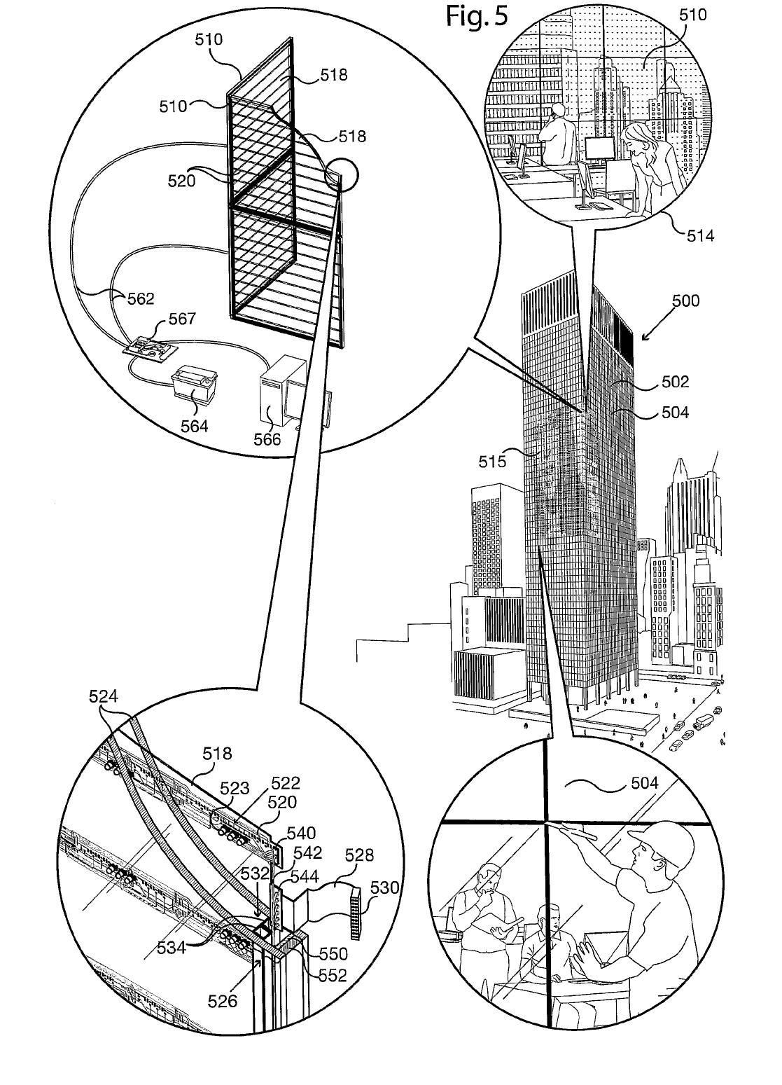

Reference is now made to FIG. 5, which is a simplified pictorial illustration of retrofitting a building including a curtain wall structure constructed and operative in accordance with a preferred embodiment of the present invention. As shown in FIG. 5, an existing building structure 500 includes a conventional curtain wall 502 including a plurality of conventional curtain wall modules 504 mounted on conventional curtain wall mounting hardware (not shown), which includes mullions and/or cables.

In accordance with a preferred embodiment of the present invention, at least some of the conventional curtain wall modules 504 are removed and curtain wall modules 510, constructed and operative in accordance with a preferred embodiment of the present invention, are mounted on the existing curtain wall mounting hardware (not shown), instead of the curtain wall modules 504. As shown in FIG. 5, the curtain wall modules 510 may be mounted on any suitable part of the building, such as a corner of the building and any other suitable surface of the building.

As described hereinabove with reference to FIG. 1, curtain wall modules 510 may be installed generally in a conventional manner but are constructed and operative to provide a visually sensible image surface when viewed from the outside and preferably are highly transparent when viewed from the inside in accordance with a preferred embodiment of the present invention, as seen at reference number 514.

In accordance with a preferred embodiment of the present invention, the resulting curtain wall portions 515 comprise a multiplicity of curtain wall modules 510. Each curtain wall module 510 preferably comprises a substrate 518, which is preferably flexible and is typically a polyester film, such as MYLAR®, TETORON® or other TEIJIN® films commercially available from DuPont Inc., though any other suitable substrate, such as polyamide films may be utilized. Alternatively, a rigid substrate such as glass may be employed.

Electrical conductors 520 are printed onto substrate 518, preferably by means of conductive ink or by any other suitable means. Preferably, the substrate 518 is generally transparent to visible light. Alternatively, the substrate 518 may be translucent or opaque. Preferably, the conductive ink is PI-2000, commercially available from Dow-Corning of Midland, Mich., USA. Any suitable type of conductor, such as other conductive inks and transparent conductive inks, may also be used.

In accordance with a preferred embodiment of the invention, clusters 522 of variously colored LEDs, preferably RGB LEDs, or other light emitting elements 523 are mounted onto substrate 518 at suitable spatial intervals therealong in electrical communication with electrical conductors 520. Preferably, an electrically conductive adhesive, such as Electrically Conductive Isotropic Adhesive 3880, commercially available from Henkel Loctite Corporation of Rocky Hills, Conn., USA, is employed for this purpose. The electrical conductors 520 preferably supply electrical power to the clusters 522 and may also provide control information thereto.

Preferably the substrate 518 bearing the conductors 520 and the clusters 522 is sealingly encased between a pair of generally parallel glass or other transparent sheets 524. A peripheral mounting and sealing rim assembly 526 joins the transparent sheets and the substrate 518 and accommodates a flat cable 528 which is coupled to conductors 520 and to a power and/or data connector 530.

As seen in FIG. 5, the peripheral mounting and sealing rim assembly 526 preferably comprises a spacer subassembly 532 which includes a pair of peripheral rim elements 534, each attached to a corresponding transparent sheet 524 by an adhesive, preferably a polysulfide adhesive, such as Thiover, commercially available from Fenzi SpA of Tribiano, Italy. The substrate 518 is preferably retained taut by frictional engagement thereof between adjacent peripheral rim elements 534.

Conductors 520, connected to clusters 522, are coupled to edge connectors 540, which in turn are coupled via cables 542 to a flat cable connector 544 on flat cable 528. One or more flat cables 528 thus provide both power and/or data connection for each curtain wall module 510 and extend through a suitable slit (not shown) formed in a peripheral edge element 550 to power and/or data connector 530. Peripheral edge element 550 is preferably spaced from spacer subassembly 532, thereby to define a channel for accommodating cables 532 and flat cable connector 544. A silicon environmental seal 552 is preferably provided on the outside periphery of peripheral edge element 550.

The various curtain wall modules 510 are preferably mounted on the existing curtain wall mounting hardware (not shown) and the power and/or data connectors 530 of adjacent modules 510 are electrically coupled to each other. Preferably, along one edge of a building there is provided data and/or power cabling 562 which interconnects to the power and/or data connectors 530 of modules 510 adjacent thereto and thus provides power and/or data connections for the entire curtain wall of a building.

The data and/or power cabling 562 is preferably coupled to a suitable power supply 564 and to a data server 566 via interface circuitry 567 for driving the clusters 522. A non-limiting example of data and/or power cabling system which provides this functionality appears in PCT Published Patent Application WO 2004/114268, the description of which is hereby incorporated by reference. It is appreciated that the various cables and wires used for purposes of the present invention may be replaced by wireless components.

It is appreciated that the curtain wall portions 515 described hereinabove may be employed in alternative embodiments as shown and described hereinbelow. The electrical conductors 520 may be coupled to one or more of light and/or sound transducers, temperature governing elements, environmental sensors, motion sensors, pressure sensors, climate control elements and energy collection and storage elements. Additionally, suitable packaging may be employed to mount the curtain wall portions 515 described hereinabove on any suitable architectural surface, including internal wall surfaces, ceilings and floors.

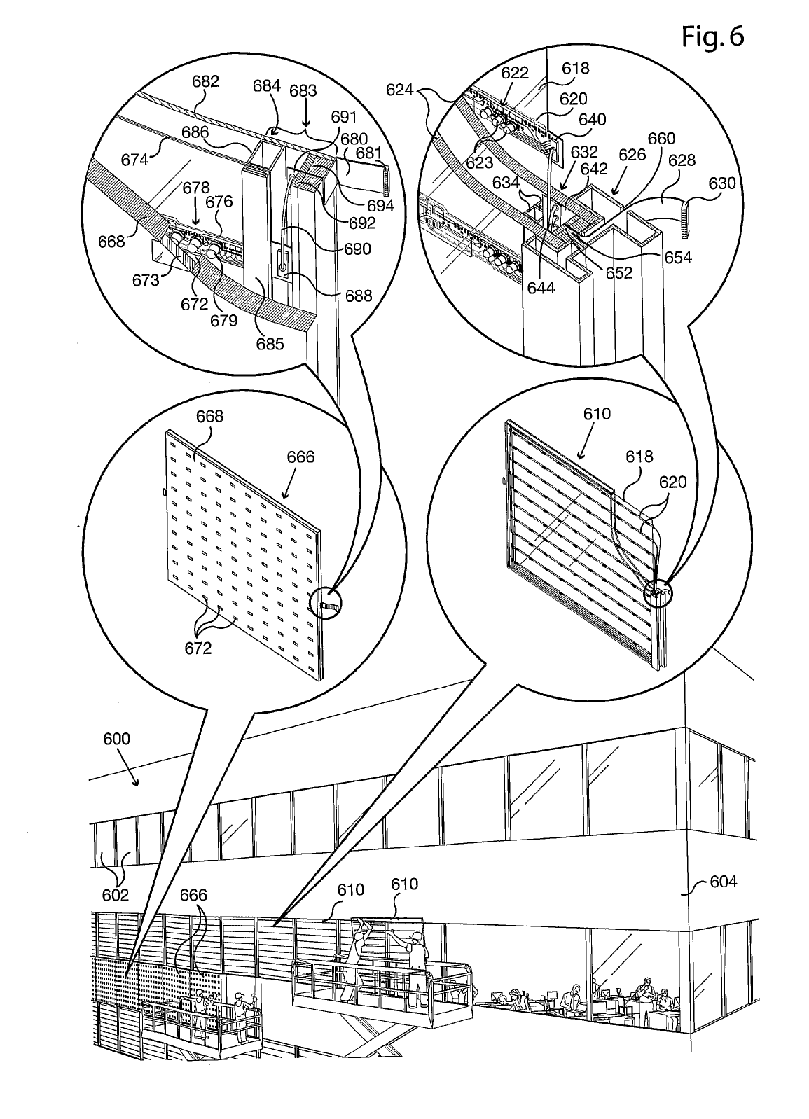

Reference is now made to FIG. 6, which is a simplified pictorial illustration of retrofitting a conventional building 600 including an exterior facade defining windows 602 and spandrel panels 604.

In accordance with a preferred embodiment of the present invention, the conventional windows 602 are removed and window modules 610, constructed and operative in accordance with a preferred embodiment of the present invention, are mounted on suitable mullions in place thereof.

As described hereinabove with reference to FIG. 1, modules 610 may be installed generally in a conventional manner but are constructed and operative to provide a visually sensible image surface when viewed from the outside and preferably are highly transparent when viewed from the inside in accordance with a preferred embodiment of the present invention.

In accordance with a preferred embodiment of the present invention, the resulting window comprises a multiplicity of modules 610, each of which comprises a substrate 618, which is preferably flexible and is typically a polyester film, such as MYLAR®, TETORON® or other TEIJIN® films commercially available from DuPont Inc., though any other suitable substrate, such as polyamide films may be utilized. Alternatively, a rigid substrate such as glass may be employed.

Electrical conductors 620 are printed onto the substrate 618, preferably by means of conductive ink, or by any other suitable means. Preferably, the substrate 618 is generally transparent to visible light. Alternatively, the substrate 618 may be translucent or opaque. Preferably, the conductive ink is PI-2000, commercially available from Dow-Corning of Midland, Mich., USA. Any suitable type of conductor, such as other conductive inks and transparent conductive ink, may also be used.

In accordance with a preferred embodiment of the invention, clusters 622 of variously colored LEDs, preferably RGB LEDs, or other light emitting elements 623 are mounted onto substrate 618 at suitable spatial intervals therealong in electrical communication with electrical conductors 620. Preferably, an electrically conductive adhesive, such as Electrically Conductive Isotropic Adhesive 3880, commercially available from Henkel Loctite Corporation of Rocky Hills, Conn., USA, is employed for this purpose. The electrical conductors 620 preferably supply electrical power to the clusters 622 and may also provide control information thereto.

Preferably the substrate 618 bearing the conductors 620 and the clusters 622 is sealingly encased between a pair of generally parallel glass or other transparent sheets 624. A peripheral mounting and sealing rim assembly 626 joins the transparent sheets and the substrate 618 and accommodates a flat cable 628 which is coupled to conductors 620 and to a power and/or data connector 630.

As seen in FIG. 6, the peripheral mounting and sealing rim assembly 626 preferably comprises a spacer subassembly 632 which includes a pair of peripheral rim elements 634, each attached to a corresponding transparent sheet 624 by an adhesive, preferably a polysulfide adhesive, such as Thiover, commercially available from Fenzi SpA of Tribiano, Italy. The substrate 618 is preferably retained taut by frictional engagement thereof between adjacent peripheral rim elements 634.

Conductors 620, connected to clusters 622, are coupled to edge connectors 640, which in turn are coupled via cables 642 to a flat cable connector 644 on flat cable 628. One or more flat cables 628 thus provide power and/or data connections for each window module 610 and extend through a suitable slit (not shown) formed in a peripheral edge element 652 to power and/or data connector 630. Peripheral edge element 652 is preferably spaced from spacer subassembly 632, thereby to define a channel for accommodating cables 642 and flat cable connector 644. A silicon environmental seal 654 is preferably provided on the outside periphery of peripheral edge element 652.

The various modules 610 are preferably suspended by suitable mullions and the power and/or data connectors 630 of adjacent modules 610 are electrically coupled to each other. The electrical coupling of the power and/or data connectors is achieved by passing each flat cable through a suitable slit 660 in the mullion preferably into the building, where the power and/or data connector is electrically connected to one or more additional power and/or data connectors of adjacent modules 610. The electrical coupling thus provides a series of modules 610 which are preferably all electrically coupled to each other.

It is appreciated that the window modules 610 described hereinabove may be employed in alternative embodiments as shown and described hereinbelow. The electrical conductors 620 may be coupled to one or more of light and/or sound transducers, temperature governing elements, environmental sensors, motion sensors, pressure sensors, climate control elements and energy collection and storage elements.

In accordance with a preferred embodiment of the present invention, spandrel panel modules 666, constructed and operative in accordance with a preferred embodiment of the present invention, are mounted in place of or over the conventional spandrel panels 604. Similarly to that described hereinabove with reference to FIG. 4, modules 666 may be similar to the rigid floor assemblies 404 and preferably are constructed and operative to provide a visually sensible image surface. As seen in FIG. 6, modules 666 preferably each comprise a rigid panel 668 which preferably is formed, as by CNC machining, with a multiplicity of apertures 672, each being sealed by a transparent or translucent cover element 673, which preferably also functions as a lens.

Disposed behind rigid panel 668 and preferably supported thereby is a substrate 674, which is preferably flexible and is typically a polyester film, such as MYLAR®, TETORON® or other TEIJIN® films commercially available from DuPont Inc., though any other suitable substrate, such as polyamide films may be utilized. Alternatively, a rigid substrate such as glass may be employed.

Electrical conductors 676 are printed onto the substrate 674, preferably by means of conductive ink or by any other suitable means. Preferably, the substrate 674 is generally transparent to visible light. Alternatively, the substrate 674 may be translucent or opaque. Preferably, the conductive ink is PI-2000, commercially available from Dow-Corning of Midland, Mich., USA. Any suitable type of conductor, such as other conductive inks and transparent conductive ink, may also be used.

In accordance with a preferred embodiment of the invention, clusters 678 of variously colored LEDs, preferably RGB LEDs, or other light emitting elements 679 are mounted onto substrate 674 at suitable spatial intervals therealong in electrical communication with electrical conductors 676. Preferably, an electrically conductive adhesive, such as Electrically Conductive Isotropic Adhesive 3880, commercially available from Henkel Loctite Corporation of Rocky Hills, Conn., USA, is employed for this purpose. The electrical conductors 676 preferably supply electrical power to the clusters 678 and may also provide control information thereto. Preferably, the clusters 678 are each aligned with one of apertures 672 in the panel 668, so as to be visible therethrough.

Preferably the substrate 674 bearing the conductors 676 and the clusters 678 is associated with a plurality of flat cables 680, each coupled to conductors 676 and to a power and/or data connector 681.

Preferably, the substrate 674 bearing the conductors 676 and the clusters 678 is sealingly encased between rigid panel 668 and a back encasing panel 682, which is suited to the building onto which the module is mounted. A peripheral mounting and sealing rim assembly 683 joins the rigid panel 668, the substrate 674 and the back encasing panel 682 and accommodates flat cable 680.

As seen in FIG. 6, the peripheral mounting and sealing rim assembly 683 preferably comprises a spacer subassembly 684 which includes a pair of peripheral rim elements 685 and 686, attached respectively to rigid panel 668 and back encasing panel 682 by an adhesive, preferably a polysulfide adhesive, such as Thiover, commercially available from Fenzi SpA of Tribiano, Italy. The substrate 674 is preferably retained taut by frictional engagement thereof between adjacent peripheral rim elements 685 and 686.

Conductors 676, connected to clusters 678, are coupled to edge connectors 688, which in turn are coupled via cables 690 to a flat cable connector 691 on flat cable 680. One or more flat cables 680 thus provide power and/or data connections for each spandrel panel modules 666 and extend through a suitable slit (not shown) formed in a peripheral edge element 692 to the power and/or data connector. Peripheral edge element 692 is preferably spaced from spacer subassembly 684, thereby to define a channel for accommodating cables 690 and flat cable connector 691. A silicon environmental seal 694 is preferably provided on the outside periphery of peripheral edge element 692.

The various spandrel panel modules 666 are preferably mounted in a conventional spandrel facade system mounting arrangement (not shown) and the power and/or data connectors of adjacent modules 666 are electrically coupled to each other.

Preferably, along one edge of a building there is provided branched data and/or power cabling (not shown) which interconnects to the power and/or data connectors 630 of modules 610 adjacent thereto and the power and/or data connectors 681 of modules 666 and thus may provide power and/or data connections for the entire outer surface of a building. It is appreciated that suitable data is provided by cabling to the various types of modules mounted on the building.

The data and/or power cabling is preferably coupled to a suitable power supply and to a data server, similar to power supply 154 and data server 156 shown in FIG. 1, for driving the clusters 622 and 678. A non-limiting example of data and/or power cabling system which provides this functionality appears in PCT Published Patent Application WO 2004/114268, the description of which is hereby incorporated by reference. It is appreciated that the various cables and wires used for purposes of the present invention may be replaced by wireless components.

It is appreciated that the window module 610 and spandrel panel modules 666 described hereinabove may be employed in alternative embodiments of the present invention. The electrical conductors 620 and 676 may be coupled to one or more of light and/or sound transducers, temperature governing elements, environmental sensors, motion sensors, pressure sensors, climate control elements and energy collection and storage elements.

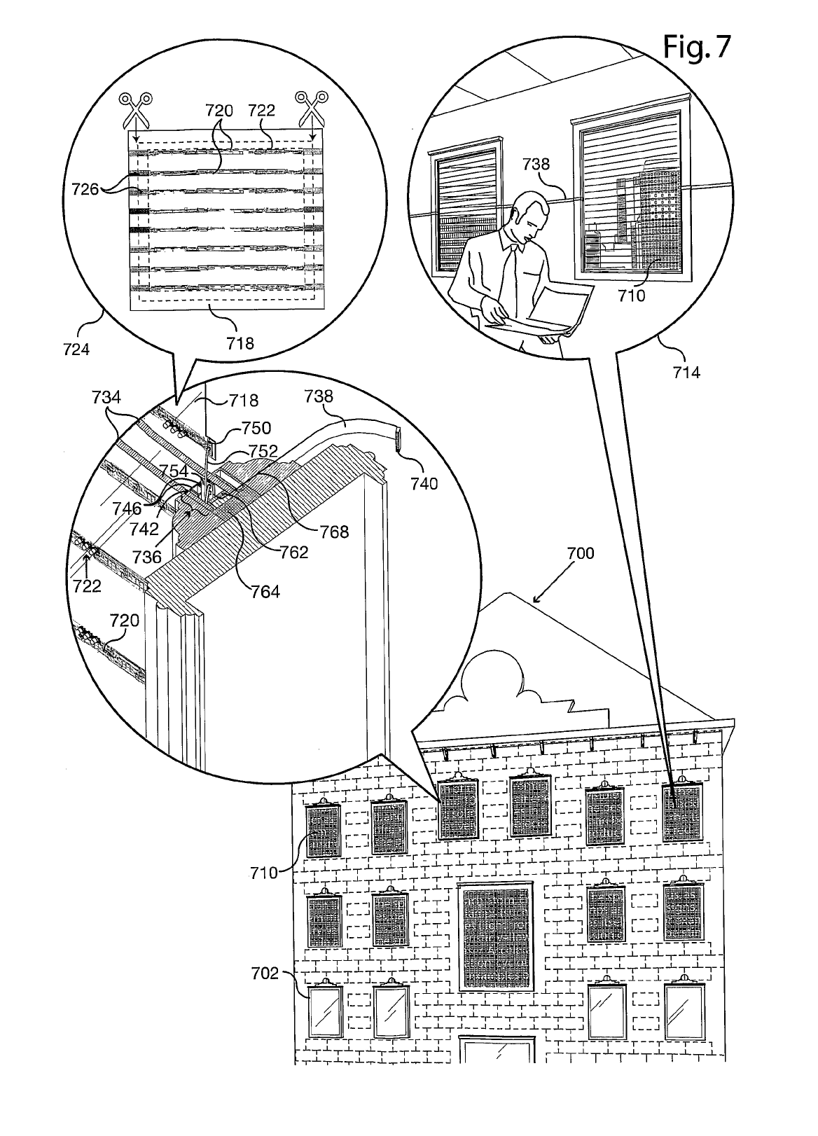

Reference is now made to FIG. 7, which is a simplified pictorial illustration of retrofitting a conventional building 700, including an exterior facade including windows 702 of various sizes. In accordance with a preferred embodiment of the present invention, the conventional windows 702 may be removed and window modules 710, constructed and operative in accordance with a preferred embodiment of the present invention, are mounted on suitable mullions in place thereof or in addition thereto.

As described hereinabove with reference to FIG. 1, modules 710 may be installed generally in a conventional manner but are constructed and operative to provide a visually sensible image surface when viewed from the outside and preferably are highly transparent when viewed from the inside in accordance with a preferred embodiment of the present invention, as seen at reference number 714.

In accordance with a preferred embodiment of the present invention, the retrofit comprises a plurality of window modules 710 in various sizes, each of which comprises a substrate 718, which is preferably flexible and is typically a polyester film, such as MYLAR®, TETORON® or other TEIJIN® films commercially available from DuPont Inc., though any other suitable substrate, such as polyamide films may be utilized. Alternatively, a rigid substrate such as glass may be employed.

Electrical conductors 720 are printed onto at least part of substrate 718, preferably by means of conductive ink or by any other suitable means. Preferably, the substrate 718 is generally transparent to visible light. Alternatively, the substrate 718 may be translucent or opaque. Preferably, the conductive ink is PI-2000, commercially available from Dow-Corning of Midland, Mich., USA. Any suitable type of conductor, such as other conductive inks and transparent conductive ink, may also be used.

In accordance with a preferred embodiment of the invention, clusters 722 of variously colored LEDs, preferably RGB LEDs, or other light emitting elements 723 are mounted onto substrate 718 at suitable spatial intervals therealong in electrical communication with electrical conductors 720. Preferably, an electrically conductive adhesive, such as Electrically Conductive Isotropic Adhesive 3880, commercially available from Henkel Loctite Corporation of Rocky Hills, Conn., USA, is employed for this purpose. The electrical conductors 720 preferably supply electrical power to the clusters 722 and may also provide control information thereto.

It is appreciated that the substrate 718 is preferably larger than the area onto which the conductors 720 are printed and the clusters 722 are mounted, as shown at reference numeral 724. Preferably, a plurality of electrical pads 726 which are typically at the edges of the conductors 720, are extended to reach the full size of the substrate 718. As seen at reference numeral 724, the module 710 may be suitably sized by cutting the substrate 718 at the edges thereof, across pads 726, preferably leaving the clusters 722 centered on the substrate 718.

Preferably the substrate 718, bearing the conductors 720 and the clusters 722, is sealingly encased between a pair of generally parallel glass or other transparent sheets 734. A peripheral mounting and sealing rim assembly 736 joins the transparent sheets 734 and the substrate 718 and accommodates a flat cable 738 which is coupled to conductors 720 and to a power and/or data connector 740.

As seen in FIG. 7, the peripheral mounting and sealing rim assembly 736 preferably comprises a spacer subassembly 742 which includes a pair of peripheral rim elements 746, each attached to a corresponding transparent sheet 734 by an adhesive, preferably a polysulfide adhesive, such as Thiover, commercially available from Fenzi SpA of Tribiano, Italy. The substrate 718 is preferably retained taut by frictional engagement thereof between adjacent peripheral rim elements 746.

Conductors 720, connected to clusters 722, are coupled to edge connectors 750, which in turn are coupled via cables 752 to a flat cable connector 754 on flat cable 738. One or more flat cables 738 thus provide power and/or data connections for each window module 710 and extend through a suitable slit (not shown) formed in a peripheral edge element 762 to power and/or data connector 740. Peripheral edge element 762 is preferably spaced from spacer subassembly 742, thereby to define a channel for accommodating cables 752 and flat cable connector 754. A silicon environmental seal 764 is preferably provided on the outside periphery of peripheral edge element 762.

The various modules 710 are preferably mounted on suitable mullions, and preferably in the original frame of the window 702, and the power and/or data connectors 740 of adjacent modules 710 are electrically coupled to each other by suitable cabling, as shown at reference numeral 714. Electrical coupling of the power and/or data connectors is achieved by passing each flat cable through a suitable slit 768 in the mullion, which is preferably created on-site, preferably into the building, where the power and/or data connector of the flat cable may be electrically connected to one or more additional power and/or data connectors of adjacent modules 710. The electrical coupling thus provides a series of modules 710 which are preferably all electrically coupled to each other.

One or more window modules 710 may be employed to replace each window in the building. Preferably along one edge of a building there is provided data and/or power cabling (not shown) which interconnects to the power and/or data connectors 740 of modules 710 adjacent thereto and thus provides power and/or data connections for the windows along an entire wall of a building.

The data and/or power cabling is preferably coupled to a suitable power supply and to a data server, similar to power supply 154 and data server 156 described hereinabove with reference to FIG. 1, for driving the clusters 722. A non-limiting example of data and/or power cabling system which provides this functionality appears in PCT Published Patent Application WO 2004/114268, the description of which is hereby incorporated by reference. It is appreciated that the various cables and wires used for purposes of the present invention may be replaced by wireless components.

It is appreciated that the window modules 710 described hereinabove may be employed in alternative embodiments, for example as shown and described hereinbelow. The electrical conductors 720 may be coupled to one or more of light and/or sound transducers, temperature governing elements, environmental sensors, motion sensors, pressure sensors, climate control elements and energy collection and storage elements.

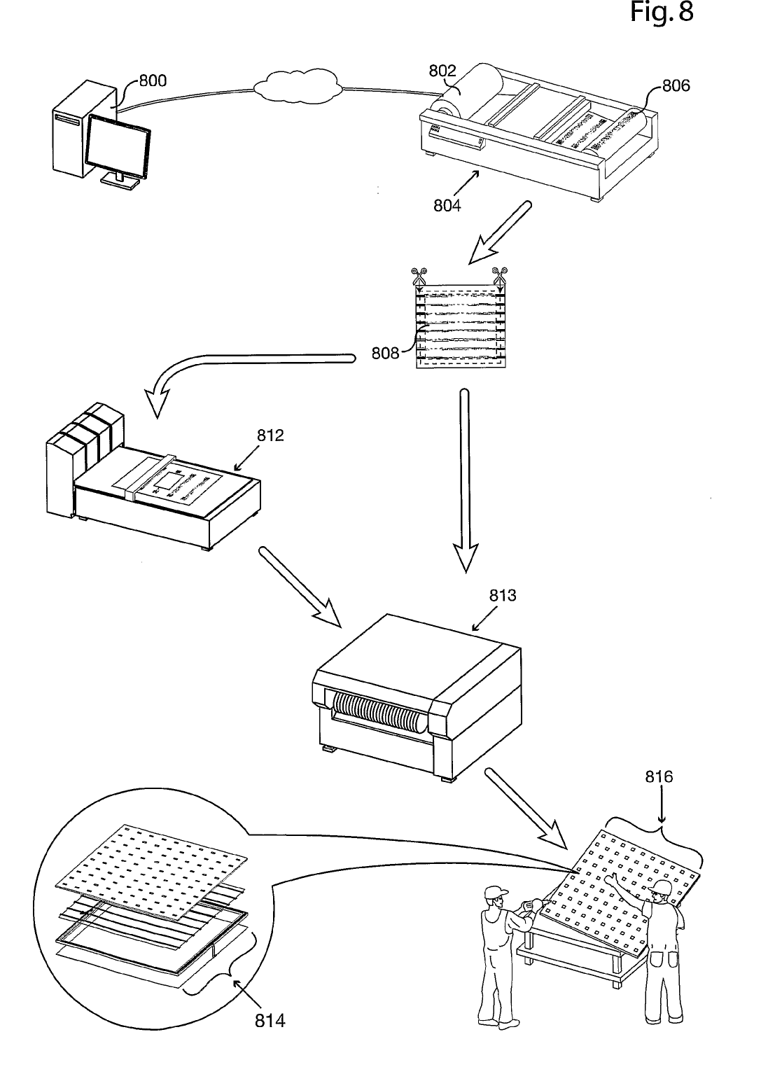

Reference is now made to FIG. 8, which is a simplified illustration of methods of manufacturing architectural surface modules in accordance with embodiments of the present invention.

A printable circuit is planned and drawn on a computer station 800, which is preferably connected to one or more suitable printers via a suitable computer network.

A roll 802 of a substrate, such as polyester or polyamide film, preferably MYLAR®, has printed thereon, by any suitable printer 804, such as a conventional screen printer, roll printer, digital printer or ink jet printer, a pattern of electrical conductors 806. The printing step may include a single stage multiple stages in order to provide a single layer electrical circuit or a multi-layer electrical circuit wherein adjacent layers of conductors are separated by suitable electrically insulative layers.

Following printing of the substrate roll 802, the roll is preferably cut into a plurality of substrate sheets 808, as by a suitable cutter (not shown). Alternatively, the substrate roll 802 may be pre-cut into multiple substrate sheets 808 of suitable dimensions for printing, and printed in an appropriate sheet printer.

An additional printing stage, indicated at reference numeral 812, may be employed for depositing, at predetermined regions on the conductor pattern 806, printable components, such as OLEDs, batteries, heating or cooling elements, or photovoltaic cells.

Alternatively and optionally, the additional printing stage indicated by reference numeral 812, may be employed for depositing a conductive adhesive at predetermined regions on the conductor pattern 806.

As seen at reference number 813, discrete components, such as electrical circuit components, audio transducers, LEDs, temperature governing elements, environmental sensors, motion sensors, pressure sensors, are preferably automatically mounted, as by using SMT pick-and-place technology, onto suitable locations on the conductor pattern 806. The mounting of discrete components indicated by reference numeral 813 may take place downstream of either or both of the additional printing stages or may take place directly following the initial printing stage indicated by reference numeral 804.

Following printing and mounting of the discrete components onto the substrate, the substrate is preferably at least partially manually encased in suitable packaging 814, as shown at reference numeral 816.

In accordance with a preferred embodiment of the present invention there is provided a building structure comprising at least one architectural surface comprising at least one substrate having electrical circuitry including patterned electrical conductors and at least one energy collection and storage assembly, formed onto the at least one substrate, the substrate being at least one of transparent and flexible. Preferably, the at least one energy collection and storage element is operative to provide power to the patterned electrical conductors and/or to at least one electrical device in the building structure.

In accordance with another preferred embodiment of the present invention there is provided a building structure comprising at least one architectural surface comprising at least one substrate having electrical circuitry including patterned electrical conductors and audio element, formed onto the at least one substrate, the substrate being at least one of transparent and flexible. Preferably, the at least one audio element is powered by the electrical conductors.

It will be apparent to persons skilled in the art that the present invention is not limited to what has been particularly shown and described hereinabove. Rather the scope of the present invention includes both combinations and subcombinations of features described and shown hereinabove as well as variations thereof which would occur to persons skilled in the art upon seeing the foregoing description and drawings and which are not in the prior art.

1. A building structure comprising:
at least one architectural surface comprising at least one substrate having electrical circuitry including patterned electrical conductors and at least one electrical component, formed onto said at least one substrate, said at least one substrate being at least one of transparent and flexible.

2. A building structure according to claim 1, and wherein said at least one electrical component is operative to be at least one of powered thereby and providing power thereto.

3-9. (canceled)

10. A building structure according to claim 1 and wherein at least one side of said at least one architectural surface comprises a visible display.

11-14. (canceled)

15. A building structure according to claim 1 and wherein said at least one architectural surface is highly transparent to visible light.

16. A building structure according to claim 1 and wherein said at least one substrate is at least one of generally translucent to visible light and generally opaque to visible light.

17-24. (canceled)

25. A building structure according to claim 1 and wherein said patterned electrical conductors comprise a first plurality of patterned electrical conductors formed onto a first side of said at least one substrate and a second plurality of patterned electrical conductors formed onto a second side of said at least one substrate.

26. A building structure according to claim 1 and wherein said at least one electrical component comprises at least one of at least one energy collection and storage element operative to provide electrical power and at least one electrically powered component.

27. (canceled)

28. A building structure according to claim 26 and wherein said patterned electrical conductors comprise electrical power conductors which supply at least one of electrical power and control information to said at least one electrically powered component.

29. (canceled)

30. A building structure according to claim 26 and wherein said at least one electrically powered component comprises at least one of a light emitting element, a sound emitting element, a temperature governing element, a climate control element, an environmental sensor, a motion sensor and a pressure sensor.

31-36. (canceled)

37. A building structure according to claim 1 and wherein said patterned electrical conductors comprise multiple layers of patterned electrical conductors electrically insulated from each other by a generally visible-light transmissive dielectric material.

38. A building structure according to claim 1 and wherein said at least one architectural surface comprises at least one of at least one environmental protective element associated with said at least one substrate and at least one space defining element associated with said at least one substrate.

39-40. (canceled)

41. A building structure according to claim 38 and wherein at least one of said at least one environmental protective element and said at least one space defining element comprises a pair of glass elements enclosing said at least one substrate therebetween.

42. A building structure according to claim 38 and wherein at least one of said at least one environmental protective element and said at least one space defining element comprises a single flexible element.

43. (canceled)

44. A building structure according to claim 42 and wherein said patterned electrical conductors are enclosed between said at least one substrate and said single flexible element.

45. A building structure according to claim 38 and wherein at least one of said at least one environmental protective element and said at least one space defining element comprises an opaque panel having at least one aperture formed therein.

46. A building structure according to claim 38 and wherein said at least one substrate and at least one of said at least one environmental protective element and said at least one space defining element are at least partially framed by a mounting assembly.

47-52. (canceled)

53. A building structure according to claim 45 and wherein at least one light emitting element associated with said patterned electrical conductors is mounted onto said at least one substrate and is aligned with said at least one aperture.

54. (canceled)

55. A building structure according to claim 46 and wherein said mounting assembly accommodates a cable associated with a connector, said cable being coupled to said patterned electrical conductors.

56. A building structure according to claim 55 and wherein said at least one architectural surface comprises a plurality of surface modules, and said cable and said connector of adjacent ones of said plurality of surface modules are in communication with each other.

57-59. (canceled)

60. A building structure according to claim 1 and wherein said at least one substrate comprises a plurality of stacked layers of substrates, each including electrical circuitry coupled to at least one electrical component.

61. A building structure according to claim 60 and wherein said plurality of stacked layers of substrates comprises at least one substrate including at least one light emitting component and at least one other substrate including at least one of at least one other light emitting component, at least one temperature governing component, at least one audio component and at least one energy collection and storage element operative to provide electrical power.

62-64. (canceled)

65. A method of manufacturing an architectural surface for a building structure, the method comprising:
providing at least one substrate which is at least one of transparent and flexible;
forming electrical circuitry including patterned electrical conductors and at least one electrical component onto said at least one substrate; and
employing said at least one substrate having said electrical circuitry formed thereon as at least part of said architectural surface.

66-67. (canceled)

68. A method according to claim 65 and also comprising, following said forming, mounting said at least one electrical component onto said at least one substrate in communication with said patterned electrical conductors.

69. (canceled)

70. A method according to claim 65 and also comprising, following said forming, mounting said at least one substrate in a mounting assembly.

71. A method according to claim 65 and also comprising, prior to said providing, removing existing architectural elements from said architectural surface.
